(19) United States
(12) Patent Application Publication
(10) Pub. No.: US 2025/0306276 A1
(43) Pub. Date: Oct. 2, 2025

(54) PROCESS INTEGRATION FLOW FOR STAIRCASE GRATINGS

(71) Applicant: Applied Materials, Inc., Santa Clara, CA (US)

(72) Inventors: Ranida WONGPIYA, Santa Clara, CA (US); Zefang WANG, Santa Clara, CA (US); Lei JIANG, San Ramon, CA (US); Liyan MIAO, Sunnyvale, CA (US); Wenhui WANG, San Jose, CA (US); Chan Juan XING, San Jose, CA (US); Rutger MEYER TIMMERMAN THIJSSEN, Sunnyvale, CA (US); Rami HOURANI, Santa Clara, CA (US); Ludovic GODET, Sunnyvale, CA (US)

(21) Appl. No.: 19/093,523

(22) Filed: Mar. 28, 2025

Related U.S. Application Data
(60) Provisional application No. 63/571,888, filed on Mar. 29, 2024.

(51) Int. Cl. G02B 6/124; G02F 1/225

(52) U.S. Cl. CPC G02B 6/124; G02F 1/2257

(57) ABSTRACT

Embodiments of the present disclosure generally relate to methods of forming waveguide combiners for augmented, virtual, and mixed reality. More specifically, embodiments described herein provide methods for forming waveguide combiners with staircase structures and binary structures. The method includes depositing a device layer comprising a plurality of device sublayers over a substrate, depositing a hardmask layer stack comprising a plurality of hardmask stack sublayers over the device layer, depositing a photoresist layer stack including a plurality of photoresist sublayers over the hardmask layer stack, etching the hardmask layer stack to produce a plurality of hardmask segments, depositing the photoresist layer stack comprising a second plurality of photoresist segments over the hardmask layer stack, the photoresist layer stack comprising the plurality of photoresist sublayers, and etching the device layer to produce a staircase structure.

### CROSS-REFERENCE TO RELATED APPLICATION

This application claims the benefit of and priority to U.S. Provisional Patent Application No. 63/571,888, filed Mar. 29, 2024, which is incorporated by reference herein in its entirety.

### BACKGROUND

### Field

Embodiments of the present disclosure generally relate to methods of forming waveguide combiners for augmented, virtual, and mixed reality. More specifically, embodiments described herein provide methods for forming waveguide combiners with staircase structures and binary structures.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguide combiners are used to assist in overlaying images. Generated light is in-coupled into a waveguide combiner, propagated through the augmented waveguide combiner, out-coupled from the augmented waveguide combiner, and overlaid on the ambient environment. Light is coupled into and out of augmented waveguide combiners using surface gratings. Accordingly, what is needed in the art are waveguide combiners with improved diffraction efficiency.

### SUMMARY

A method of forming a waveguide combiner is disclosed. The method includes depositing a device layer comprising a plurality of device sublayers over a substrate, depositing a hardmask layer stack comprising a plurality of hardmask stack sublayers over the device layer, depositing a photoresist layer stack including a plurality of photoresist sublayers over the hardmask layer stack, etching the hardmask layer stack to produce a plurality of hardmask segments, depositing the photoresist layer stack comprising a second plurality of photoresist segments over the hardmask layer stack, the photoresist layer stack comprising the plurality of photoresist sublayers, and etching the device layer to produce a staircase structure.

In another embodiment, a method of forming a waveguide combiner is disclosed. The method includes depositing a device layer comprising a plurality of device sublayers over a substrate, depositing a hardmask layer stack comprising a plurality of hardmask stack sublayers over the device layer, depositing a photoresist layer stack comprising a plurality of photoresist sublayers over the hardmask layer stack, wherein at least one photoresist sublayer is an optical planarizing layer (OPL), etching the hardmask layer stack to produce a plurality of hardmask segments, depositing the photoresist layer stack comprising a second plurality of photoresist segments over the hardmask layer stack, the photoresist layer stack comprising the plurality of photoresist sublayers, etching the device layer to produce at least one step the at least one step forming a staircase structure, trimming a sublayer of the photoresist layer stack, the sublayer being an optical planarizing layer (OPL) horizontally, removing the OPL and the plurality of hardmask segments, removing at least one hardmask stack sublayer, depositing a block photoresist over at least the staircase structure, etching the device layer to produce binary structures, and removing at least one hardmask layer stack sublayer.

In another embodiment, a method of forming a waveguide combiner is disclosed. The method includes depositing a device layer comprising a plurality of device sublayers over a substrate, depositing a hardmask layer stack comprising a plurality of hardmask stack sublayers over the device layer, depositing a photoresist layer stack comprising a plurality of photoresist sublayers over the hardmask layer stack, etching the hardmask layer stack to produce a plurality of hardmask segments, depositing the photoresist layer stack comprising a second plurality of photoresist segments over the hardmask layer stack, the photoresist layer stack comprising the plurality of photoresist sublayers, etching the device layer to produce at least a first step the at least the first step forming a staircase structure, trimming a sublayer of the photoresist layer stack, the sublayer being an optical planarizing layer (OPL) horizontally, repeating etching the device layer and trimming the OPL horizontally to produce a second step of the staircase structure, repeating etching the device layer and trimming the OPL horizontally to produce a third step of the staircase structure, and removing the OPL and the plurality of hardmask segments.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a perspective, frontal view of a waveguide combiner, according to certain embodiments.

FIG. 1B is a schematic, cross-sectional view of a waveguide combiner, according to certain embodiments.

FIG. 1C is a schematic, cross-sectional view of a first grating, according to certain embodiments.

FIG. 2 is a flow diagram of a method of forming a waveguide combiner, according to certain embodiments.

FIGS. 3A-3M are schematic, cross-sectional views of a portion of a substrate during a method for forming a waveguide combiner, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to methods of forming waveguide combiners (e.g., waveguides) for augmented, virtual, and mixed reality. More specifically, embodiments described herein provide methods for forming waveguides with staircase structures and binary structures. The waveguides include a plurality of gratings. Each grating may be a first grating (e.g., an incoupler), a second grating (e.g., an exit pupil expander), or a third grating (e.g., an outcoupler). The waveguide includes a plurality of structures (e.g., a plurality of grating structures). Regions of the plurality of structures correspond to different gratings. The plurality of structures of the incoupler are staircase structures. The plurality of structures of the exit-pupil-expander and the outcoupler are binary structures. In one or more embodiments, the incoupler is metalized (e.g., a metal layer is disposed over the staircase structures of the incoupler). The plurality of structures are formed by a method with operations drawn to a litho-etch process cycle. The litho-etch process cycle allows for different types of structures to be formed on the same substrate. For example, the disclosed method allows for the incoupler to include staircase structures while the outcoupler and the exit-pupil-expander include binary structures. The varying types of structures included on the waveguide provides an increased diffraction efficiency in at least the incoupler. In one or more embodiments, the incoupler is metalized to further increase the diffraction efficiency.

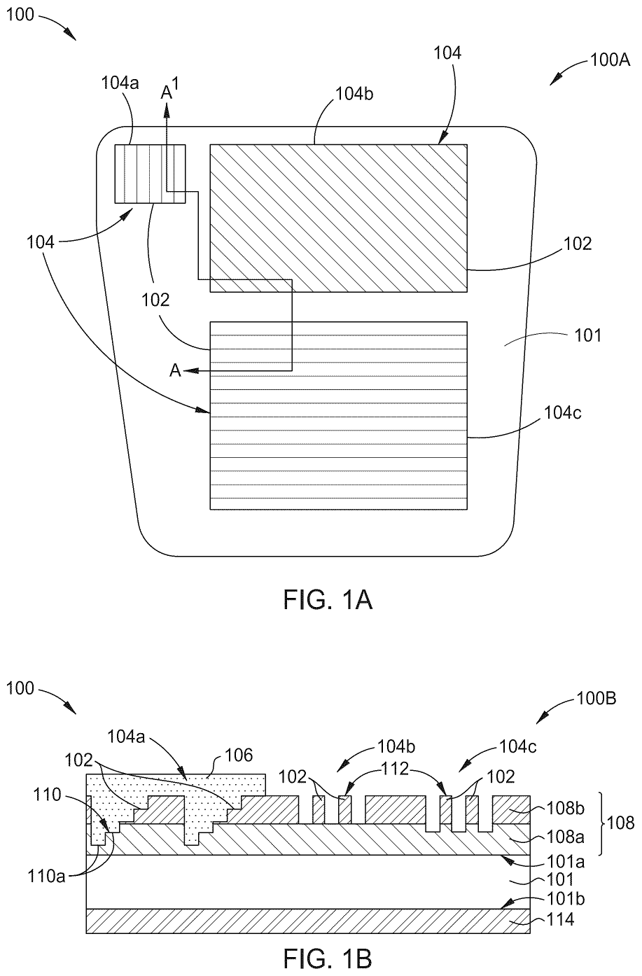

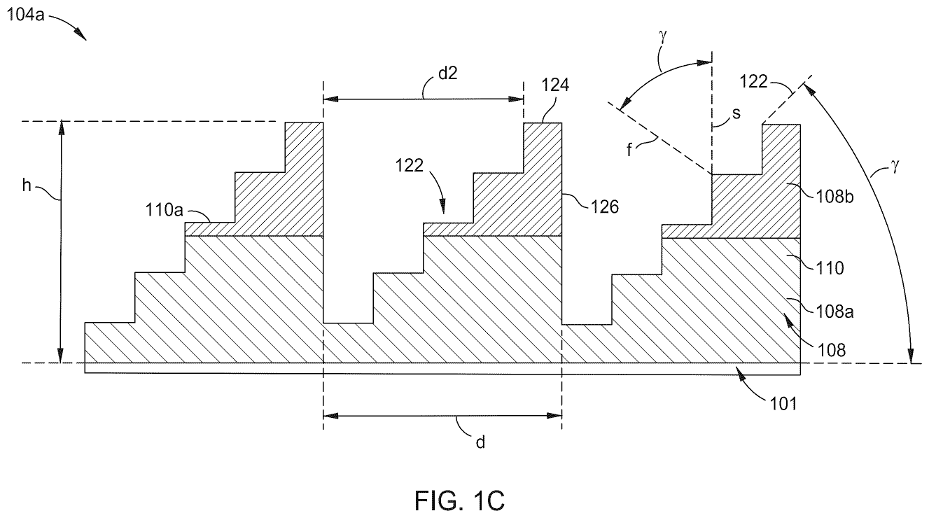

FIG. 1A is a perspective, frontal view 100A of a waveguide 100. FIG. 1B is a schematic, cross-sectional view 100B along line A-A′ shown in FIG. 1A of a waveguide 100. It is to be understood that the waveguide 100 described below is an exemplary waveguide. The waveguide 100 is an augmented reality waveguide combiner. The waveguide 100 includes a plurality of structures 102. The plurality of structures 102 can be nanostructures having sub-micron dimensions, e.g., nano-sized dimensions, such as critical dimensions less than 1 μm. Regions of the plurality of structures 102 can correspond to one or more gratings 104, such as a first grating 104a, a second grating 104b, and a third grating 104c. The plurality of structures 102 may be referred to as a plurality of grating structures.

The waveguide 100 includes a first grating 104a corresponding to an incoupler, a second grating 104b corresponding to an exit-pupil-expander, and a third grating 104c corresponding to an outcoupler. The structures 102 of the first grating 104a are staircase structures 110. The first grating 104a including the staircase structures 110 is a blazed grating. In one or more embodiments, as shown in FIG. 1B, a metal layer 106 is disposed over the staircase structures 110. The structures 102 of the second grating 104b and the third grating 104c are binary structures 112. In one or more embodiments, as shown in FIG. 1B, the binary structures 112 of the second grating 104b have a different depth than the binary structures 112 of the third grating 104c. In one or more embodiments, the binary structures 112 of the second grating 104b are a same depth as the binary structures 112 of the third grating 104c. The binary structures 112 have a vertical grating structure shape, as shown in FIG. 1B. The staircase structures 110 include a plurality of steps 110a along a blazed surface 122, as shown in 1C. The binary structures 112 include a vertical linear shape, as shown in FIG. 1B.

FIG. 1C is a schematic, cross-sectional view of a first grating 104a. The first grating 104a is the input coupler of the waveguide 100. The method 200 described herein forms the staircase structures 110. Each of the staircase structures 110 includes a blazed surface 122, a top surface 124, a sidewall 126, a depth h, and a linewidth d. The blazed surface 122 has a plurality of steps 110a. In one embodiment, which can be combined with other embodiments described herein, the blazed surface 122 includes at least 3 steps 110a, such as greater than 16 steps 110a, for example 32 steps 110a. The blazed surface 122 has a blazed angle γ and a blazed line width d2. The blazed angle γ is the angle between the blazed surface 122 and the surface parallel to the substrate 101 and the angle between the surface s normal of the substrate 101 and facet normal f of the blazed surface 122. The depth h corresponds to the height of the sidewall 126 and the linewidth d corresponds to the distances between sidewalls 126 of adjacent staircase structures 110. The blazed line width d2 corresponds to a difference between the linewidth d and a width of the top surface 124 of each staircase structure 110. However, it should be understood that in one or more embodiments, the bottom most trench may be any width, without being tied to the angle γ.

In one embodiment, which can be combined with other embodiments described herein, the blazed angle γ of two or more staircase structures 110 are different. In another embodiment, which can be combined with other embodiments described herein, the blazed angle γ of two or more staircase structures 110 are the same. In one embodiment, which can be combined with other embodiments described herein, the depth h of two or more staircase structures 110 are different. In another embodiment, which can be combined with other embodiments described herein, the depth h of two or more staircase structures 110 are the same. In one embodiment, which can be combined with other embodiments described herein, the linewidths d of two or more staircase structures 110 are different. In another embodiment, which can be combined with other embodiments described herein, the linewidths d of one or more staircase structures 110 are the same.

The structures 102 are formed in a device layer 108. The device layer may include one or more device sublayers. For example, as shown in FIG. 1A, the device layer 108 includes a first device sublayer 108a and a second device sublayer 108b. In one or more embodiments, the one or more sublayers (e.g., the first device sublayer 108a and the second device sublayer 108b) include a same material. In one or more embodiments, the one or more sublayers (e.g., the first device sublayer 108a and the second device sublayer 108b) include a different material. As shown in FIG. 1B, the staircase structures 110 are disposed in at least the second device sublayer 108b and at least partially in the first device sublayer 108a. However, it should be understood that in one or more embodiments, the staircase structures 110 are disposed through as many sublayers as required. In one or more embodiments, the staircase structures 110 extend at least partially into the device layer 108. For example, as shown in FIGS. 1B and 1C, the staircase structures 110 extend at least partially through the first device sublayer 108a and the second device sublayer 108b. In one or more embodiments, the device layer 108 is one layer. When there is one device layer 108, the staircase structures extend through the device layer 108. The binary structures 112 are disposed through at least one sublayer (e.g., the first device sublayer 108a) of the device layer 108. In one or more embodiments, the binary structures 112 include varying depths through the device layer 108. The varying depths allow for an improved performance of the device. For example, as shown in FIG. 1B, the binary structures 112 of the second grating 104b extend through the second device sublayer 108b, and the binary structures 112 of the third grating 104c extend through the second device sublayer 108b and at least partially though the first device sublayer 108a. However, it should be understood that in one or more embodiments, the binary structures 112 are disposed through as many sublayers as required. Incorporating different types of structures 102 (e.g., the binary structures 112 or the staircase structures 110) in the device layer 108 of the plurality of gratings 104 enables a high diffraction efficiency for AR glasses applications.

The sublayers (e.g., the first device sublayer 108a and the second device sublayer 108b) include, but are not limited to, silicon oxycarbide (SiOC), titanium oxide (TiOₓ) (e.g., titanium dioxide (TiO₂)), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), titanium silicon oxide, silicon carbon-nitride (SiCN) containing materials, or combinations thereof.

The substrate 101 may be formed from any suitable material, provided that the substrate 101 can adequately transmit light in a selected wavelength or wavelength range and can serve as an adequate support for the waveguide 100 described herein. The substrate 101 includes a front side 101a and a back side 101b. The device layer 108 is disposed over the front side 101a of the substrate 101. In one or more embodiments, a back side device layer 114 is disposed over the back side 101b of the substrate 101. The back side device layer 114 is an anti-reflective coating. In one or more embodiments, the back side device layer 114 includes a silicon oxide coating or a material coating with anti-reflective properties. In one or more embodiments, the back side device layer 114 includes silicon oxide.

In one or more embodiments, the substrate 101 includes amorphous dielectrics, non-amorphous dielectrics, crystalline dielectrics, silicon oxide, polymers, and combinations thereof. In one or more embodiments, which may be combined with other embodiments described herein, the substrate 101 includes glass, silicon (Si), silicon dioxide (SiO₂), germanium (Ge), silicon germanium (SiGe), indium phosphide (InP), gallium arsenide (GaAs), gallium nitride (GaN), fused silica, quartz, sapphire (Al₂O₃), silicon carbide (SiC), lithium niobate (LiNbO₃), indium tin oxide (ITO), or combinations thereof. In other embodiments, which may be combined with other embodiments described herein, the substrate 101 includes high-refractive-index glass. The high-refractive-index glass includes greater than 2 percent by weight of lanthanide (Ln), titanium (Ti), tantalum (Ta), or combination thereof. In one or more embodiments, which can be combined with other embodiments, the substrate can be configured to transmit wavelengths from 100 to 3000 nanometers.

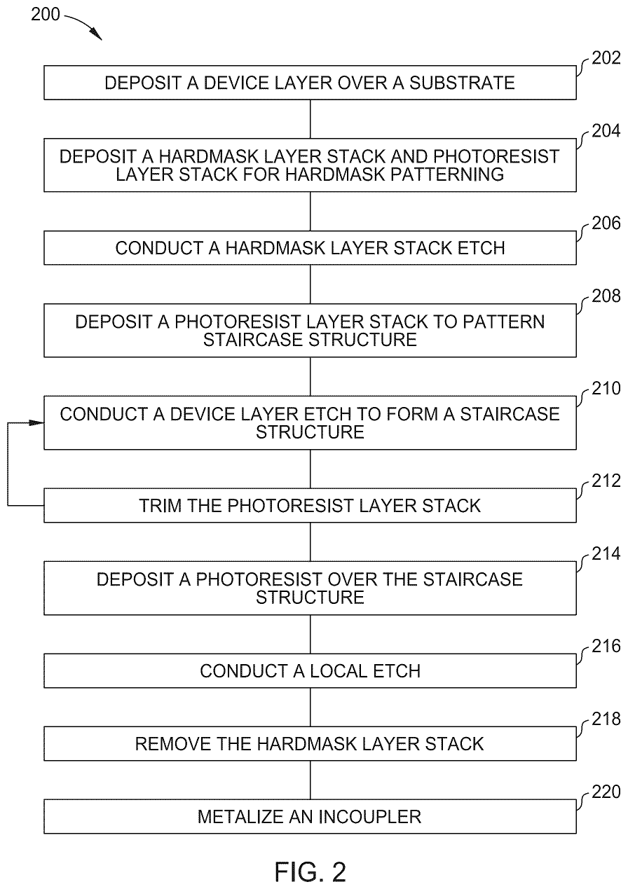

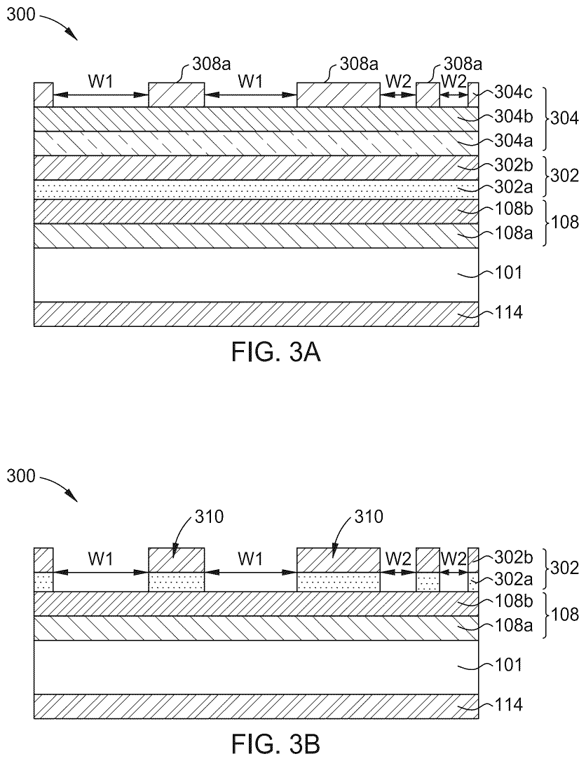

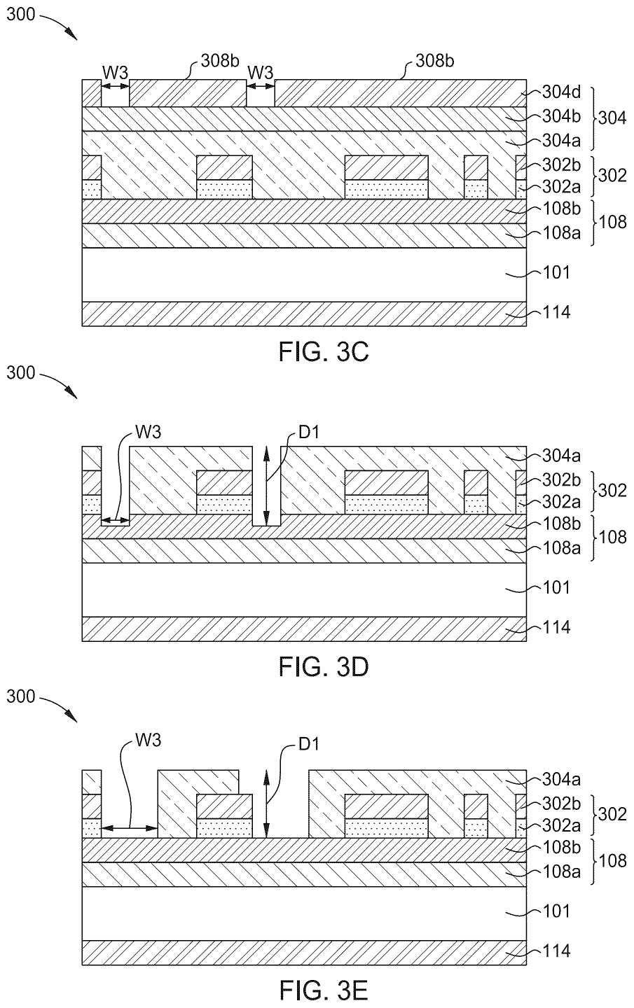

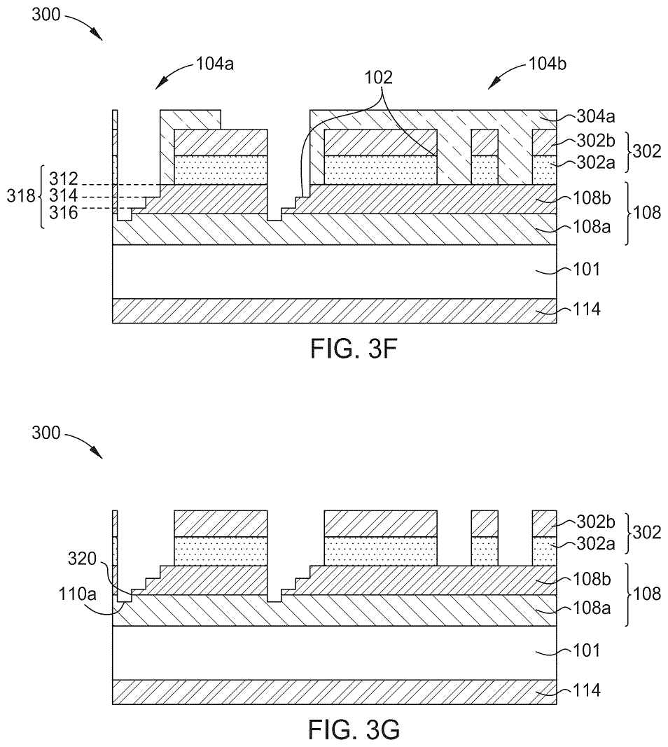

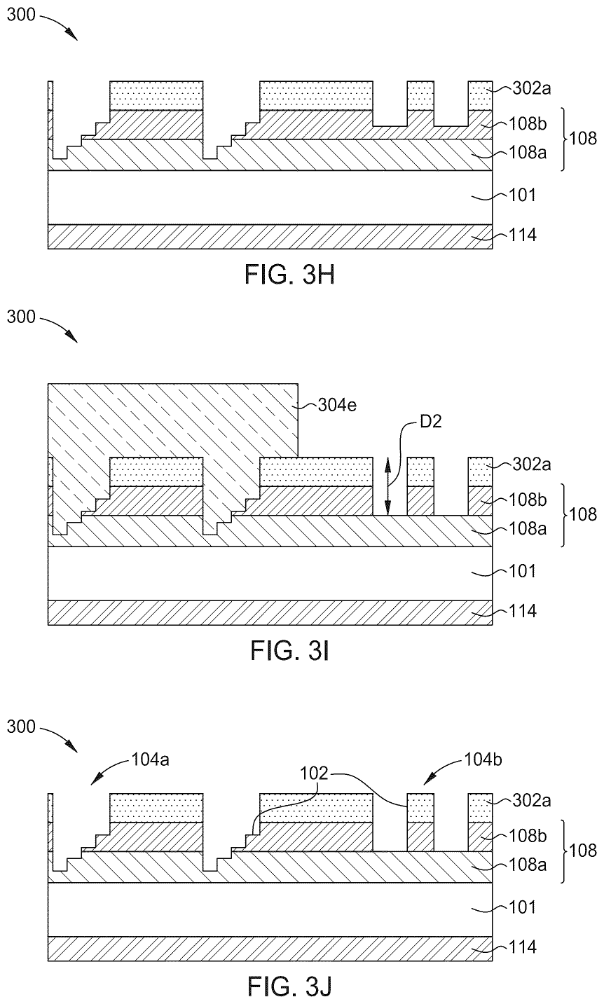

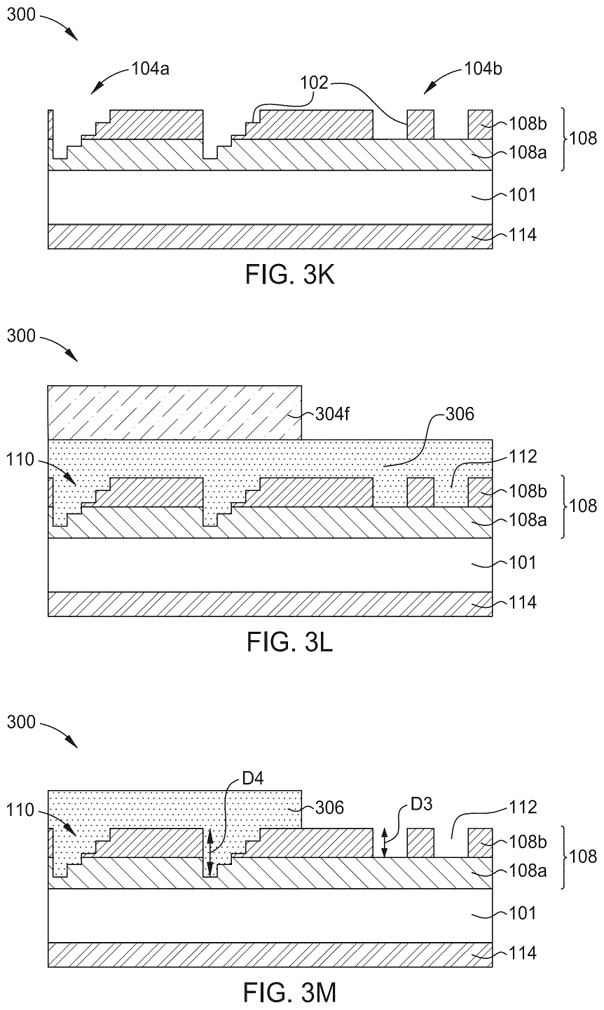

FIG. 2 is a flow diagram of a method 200 of forming a waveguide combiner (e.g. waveguide 100). FIGS. 3A-3M are schematic, cross-sectional views of a portion 300 of a substrate 101 during the method 200 for forming a waveguide 100. The portion 300 of the waveguide combiner corresponds to the first grating 104a and the second grating 104b of the waveguide 100 to be formed. The method 200 includes operations drawn to a litho-etch process cycle to form a waveguide 100 on a substrate 101 where at least two different types of structures 102 (e.g., the staircase structures 110 and the binary structures 112) are formed.

At operation 202 as shown in FIG. 3A, at least one device layer 108 is deposited over the substrate 101. In one or more embodiments, a device layer 108 is deposited over a front side 101a of the substrate 101 and a back side device layer 114 is deposited over the back side 101b of the substrate 101. The device layer 108 includes a plurality of device sublayers (e.g., a first device sublayer 108a and a second device sublayer 108b). Each sublayer of the plurality of sublayers is deposited in sequence over the substrate 101. Any suitable method for deposition of the device layer 108 can be used. Examples of suitable thin film deposition methods include a physical vapor deposition (PVD) process (e.g., ion beam sputtering, magnetron sputtering, e-beam evaporation), a chemical vapor deposition (CVD) process, a plasma enhanced chemical vapor deposition (PECVD) process, an atomic layer deposition (ALD) process, an inkjet printing process, or a three-dimensional (3D) printing process.

At operation 204, a hardmask layer stack 302 and a photoresist layer stack 304 are deposited and patterned on the substrate 101. The hardmask layer stack 302 includes a plurality of hardmask stack sublayers. The photoresist layer stack includes a plurality of photoresist sublayers. For example as shown in FIG. 3A, the photoresist layer stack 304 includes an optical planarazing layer (OPL) 304a, a silicon containing anti-reflective coating (SiARC) layer 304b, and a photoresist 304c. In one or more embodiments, the OPL 304a is a lithography carbon based mask. The hardmask layer stack 302 includes a first hardmask layer 302a and a second hardmask layer 302b. In one or more embodiments, the first hardmask layer 302a includes chromium or titanium nitride (TiN). In one or more embodiments, the second hardmask layer 302b includes SiOx or a different material operable to provide support in the hardmask etching process. In one or more embodiments, the hardmask layer stack 302 and the photoresist layer stack 304 are deposited over the device layer 108, as shown in FIG. 3A. At operation 204, at least the photoresist 304c is patterned to include a first plurality of photoresist segments 308a such that the distance between the first plurality of photoresist segments 308a correspond to a desired pattern in the hardmask layer stack 302. For example, as shown in FIG. 3A, the first plurality of photoresist segments 308a are spaced at a distance for the desired width of the gap between the structures 102 (e.g., the staircase structure width W1 and the binary structure width W2). The first plurality of photoresist segments 308a may be formed by a lithography process, such as photolithography or digital lithography, or by laser ablation process.

Any suitable method for deposition of the hardmask layer stack 302 and the photoresist layer stack 304 can be used. Examples of suitable thin film deposition methods include a spin coating process, a physical vapor deposition (PVD) process (e.g., ion beam sputtering, magnetron sputtering, e-beam evaporation), a chemical vapor deposition (CVD) process, a plasma enhanced chemical vapor deposition (PECVD) process, an atomic layer deposition (ALD) process, an inkjet printing process, or a three-dimensional (3D) printing process.

At operation 206, as shown in FIG. 3B, a hardmask layer stack etch is conducted. In one or more embodiments, the hardmask layer stack 302 is etched according to the pattern of the first plurality of photoresist segments 308a shown in FIG. 3A. In one or more embodiments, to etch the hardmask layer stack 302, the substrate 101 is exposed to a plasma etchant, such as radicals and ion beams. In one or more embodiments, the plasma etchant may include etching processes, such as ion etching and reactive ion etching (RIE). In one or more embodiments, the etch process is a wet etch. In one or more embodiments, the etch process is a dry etch. The etch process etches through the plurality of layers of the hardmask layer stack 302 (e.g., the first hardmask layer 302a and the second hardmask layer 302b) and the photoresist layer stack 304 such that a pattern is formed in the hardmask layer stack 302, as shown in FIG. 3B. The hardmask layer stack segments 310 correspond to the width W1 and the width W2 defined by the first plurality of photoresist segments 308a. Further, the widths correspond to the desired widths of the structures 102 shown in FIG. 1B. Further, as shown in FIG. 3B, the photoresist layer stack 304 is removed (e.g., etched) away from the substrate 101.

At operation 208, as shown in FIG. 3C, a photoresist layer stack 304 is deposited over the substrate 101. The OPL 304a is deposited over the hardmask layer stack 302 such that the OPL 304a contacts a portion of the device layer 108 (e.g., the OPL 304a extends between the hardmask layer stack segments 310 and contacts the device layer 108). A SiARC layer 304b and a photoresist 304c are disposed over the OPL 304a. The photoresist 304c is patterned to form the first step of the plurality of steps 110a in the staircase structure 110. As shown in FIG. 3C, the photoresist 304c pattern includes a second plurality of photoresist segments 308b. The second plurality of photoresist segments 308b are offset from the hardmask layer stack segments 310 and the device layer 108 such that at least a portion of the hardmask layer stack segments 310 are protected by the photoresist 304c. As shown in FIG. 3C, a space between the second plurality of photoresist segments 308b includes a width W3 which allows for the layers below (e.g., the SiARC layer 304b, OPL 304a, and the device layer 108) to be exposed to an etching process. The width W3 corresponds to the width of the first step of the plurality of steps 110a of the staircase structure 110.

At operation 210, a device layer etch is conducted to form a step of the plurality of steps 110a of the staircase structure 110. The device layer 108 is exposed to an etchant through the space between the second plurality of photoresist segments 308b. In one or more embodiments, the etching process includes an all in one etch recipe to etch the device layer 108 according to the pattern created by the hardmask layer stack 302 and the OPL 304a. In one or more embodiments, a lithography carbon mask is the OPL 304a and is used to during the etch process. In one or more embodiments, the etching process includes ion etching or RIE. The plasma etchant includes radicals and ion beams. In one or more embodiments, the etch process is a wet etch. In one or more embodiments, the etch process sis a dry etch. The etchant etches a first vertical depth D1 as shown in FIG. 3D. The first vertical depth D1 is at least partially though the device layer 108. As shown in FIG. 3D, the photoresist 304c and the SiARC layer 304b are etched away.

At operation 212, the OPL 304a (of the photoresist layer stack 304) is trimmed by an isotropic ion etching process that recesses the OPL 304a horizontally. In one or more embodiments, the OPL 304a is trimmed vertically and horizontally. Trimming the OPL 304a exposes an additional portion of the device layer 108. For example, as shown in FIG. 3E, the width W3 is extended after trimming the OPL 304a. The OPL 304a protects the layers (e.g., the hardmask layer stack 302 and the device layer 108) from unwanted etching in particular areas while exposing areas to be etched in order to form the staircase structure 110. For example, as shown in FIGS. 3D and 3E, the OPL 304a is disposed over at least the binary structures during operations 210 and 212.

Operation 210 and 212 are repeated until the staircase structure 110 is formed. As shown in FIG. 3F, sequentially repeating operation 210 and 212 forms a plurality of steps 110a with a plurality of widths 318. For example, as shown in FIG. 3F, a first width 312, a second width 314, and a third width 316 form individual steps of the plurality of steps 110a. In one or more embodiments, the first width 312 is greater than the second width 314 and the second width 314 greater than the third width 316. Each step of the plurality of steps 110a includes a sidewall portion 320 as shown in FIG. 3G. Operation 210 and 212 are repeated until the desired number of the plurality of steps 110a are formed. A final etch process is performed to remove the remaining OPL 304a and the second hardmask layer 302b after the staircase structure 110 is complete. In one or more embodiments, the OPL 304a is ashed. In one or more embodiments, the OPL 304a is etched by an O₂ based etchant gas. In one or more embodiments, the second hardmask layer 302b is etched by a fluorine (F) gas until the second hardmask layer 302b is removed from the substrate 101. The complete staircase structure 110 is shown in FIG. 3H.

At operation 214, as shown in FIG. 3I, a photoresist 304e is deposited over the staircase structures 110. At operation 216, a local etch is conducted to form the binary structures 112. In one or more embodiments, the etching process includes ion etching or RIE. The plasma etchant includes radicals and ion beams. The binary structures 112 are etched until they reach a desired depth. For example, as shown in FIG. 3I, the binary structures 112 are etched a depth, D2, into the device layer 108. As shown in FIG. 3J, after the local etch is conducted the photoresist 304e is removed. At operation 218, as shown in FIG. 3K, the first hardmask layer 302a is removed. The first hardmask layer 302a is removed by a wet etch process. In one or more embodiments, the final device is formed after operation 214 (e.g., the incoupler is not metalized).

At operation 220 the first grating 104a (e.g., the incoupler) is metalized. At operation 220, a metal material 306 is deposited over the substrate 101. The metal material 306 includes aluminum or any other metal. The metal material 306 is deposited by PVD or any other suitable thin film deposition process. As shown in FIG. 3L, the metal material 306 is deposited between the structures 102. A patterned photoresist 304f is deposited over the metal material 306 and the metal material 306 is etched. The patterned photoresist 304f is deposited such that it is deposited over the staircase structures 110. The metal material 306 etching process includes a wet etch process. The plasma etchant includes radicals and ion beams. The metal material 306 etching process etches away the metal material 306 disposed over the binary structures 112 to form a metalized staircase incoupler as shown in FIG. 3M and FIG. 1B. As shown in FIG. 3M, the depth D3 of the binary structures 112 is different than the depth D4 of the staircase structures 110. In one or more embodiments, the depth D3 of the binary structures 112 is the same as the depth D4 of the staircase structures. The depth of any structures 102 can be adjusted according to device fabrication needs.

In one or more embodiments, the method 200 operations can be performed in any order. For example, the binary structures 112 are formed before the staircase structures. In this example, operation 202, operation 204, and operation 206 are performed. Next, operation 214 and operation 216 are performed to form the binary structures 112. Next, operation 208, operation 210, operation 212 are performed (and operation 210 and operation 212 are repeated) to form the staircase structures 110. Finally, operation 218 and operation 220 are performed to complete the waveguide 100.

In one or more embodiments, the operations associated with forming a staircase structure 110 may be performed on a different grating region in addition to the incoupler. For example, staircase structures 110 may be formed in the outcoupler or the exit-pupil-expander.

Overall, embodiments of the present disclosure generally relate to methods of forming waveguides for augmented, virtual, and mixed reality. More specifically, embodiments described herein provide methods for forming waveguides with staircase structures and binary structures. The staircase structures are formed as part of the incoupler of the waveguide. Further, a plurality of binary structures are formed as part of the outcoupler and exit-pupil-expander. The method including a litho-etch process cycle allows for the different structures to be formed on the same substrate of the waveguide. The variety of structure type in the different gratings allows for an increased incoupling diffraction efficiency.

While the foregoing is directed to examples of the present disclosure, other and further examples of the disclosure may be devised without departing from the basic scope thereof, and the scope thereof is determined by the claims that follow.

What is claimed is:

1. A method of forming a waveguide combiner, comprising:
depositing a device layer comprising a plurality of device sublayers over a substrate;
depositing a hardmask layer stack comprising a plurality of hardmask stack sublayers over the device layer;
depositing a photoresist layer stack comprising a plurality of photoresist sublayers over the hardmask layer stack;
etching the hardmask layer stack to produce a plurality of hardmask segments;
depositing the photoresist layer stack comprising a second plurality of photoresist segments over the hardmask layer stack, the photoresist layer stack comprising the plurality of photoresist sublayers; and
etching the device layer to produce a staircase structure.

2. The method of claim 1, further comprising:
trimming a sublayer of the photoresist layer stack, the sublayer being an optical planarizing layer (OPL) horizontally;
repeating etching the device layer and trimming the OPL horizontally to produce a plurality of steps of the staircase structure; and
removing the OPL and the plurality of hardmask segments.

3. The method of claim 1, wherein the plurality of photoresist sublayers comprise an optical planarizing layer (OPL), a silicon containing anti-reflective (SiARC) layer, and a photoresist comprising a first plurality of photoresist segments.

4. The method of claim 1, wherein the plurality of hardmask stack sublayers of the hardmask layer stack comprise a first hardmask layer and a second hardmask layer.

5. The method of claim 4, further comprising:
removing the second hardmask layer;
depositing a block photoresist over at least the staircase structure;
etching the device layer to produce binary structures; and
removing the first hardmask layer.

6. The method of claim 1, wherein the second plurality of photoresist segments are offset from the plurality of hardmask segments of the hardmask layer stack such that a portion of each of the plurality of second photoresist segments are disposed over a portion of the device layer or the substrate.

7. The method of claim 1, wherein the plurality of device sublayers of the device layer comprise silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), titanium silicon oxide, silicon carbon-nitride (SiCN) containing materials, or combinations thereof.

8. The method of claim 1, further comprising:
depositing a metal material over the substrate;
depositing a photoresist over the metal material deposited over the staircase structure; and
etching the metal material.

9. A method of forming a waveguide combiner, comprising:
depositing a device layer comprising a plurality of device sublayers over a substrate;
depositing a hardmask layer stack comprising a plurality of hardmask stack sublayers over the device layer;
depositing a photoresist layer stack comprising a plurality of photoresist sublayers over the hardmask layer stack, wherein at least one photoresist sublayer is an optical planarizing layer (OPL);
etching the hardmask layer stack to produce a plurality of hardmask segments;
depositing the photoresist layer stack comprising a second plurality of photoresist segments over the hardmask layer stack, the photoresist layer stack comprising the plurality of photoresist sublayers;
etching the device layer to produce at least one step the at least one step forming a staircase structure;
trimming a sublayer of the photoresist layer stack, the sublayer being an optical planarizing layer (OPL) horizontally;
removing the OPL and the plurality of hardmask segments;
removing at least one hardmask stack sublayer;
depositing a block photoresist over at least the staircase structure;
etching the device layer to produce binary structures; and
removing at least one hardmask layer stack sublayer.

10. The method of claim 9, further comprising:
before removing the OPL and the plurality of hardmask segments, repeating etching the device layer and trimming the OPL horizontally to produce a second step of the staircase structure.

11. The method of claim 10, wherein repeating etching the device layer and trimming the OPL horizontally continues until a plurality of steps are formed of the staircase structure.

12. The method of claim 9, wherein the second plurality of photoresist segments are offset from the plurality of hardmask segments of the hardmask layer stack such that a portion of each of the plurality of second photoresist segments are disposed over a portion of the device layer or the substrate.

13. The method of claim 9, further comprising:
depositing a metal material over the substrate;
depositing a photoresist over the metal material deposited over the staircase structure; and
etching the metal material.

14. A method of forming a waveguide combiner, comprising:
depositing a device layer comprising a plurality of device sublayers over a substrate;
depositing a hardmask layer stack comprising a plurality of hardmask stack sublayers over the device layer;
depositing a photoresist layer stack comprising a plurality of photoresist sublayers over the hardmask layer stack;
etching the hardmask layer stack to produce a plurality of hardmask segments;
depositing the photoresist layer stack comprising a second plurality of photoresist segments over the hardmask layer stack, the photoresist layer stack comprising the plurality of photoresist sublayers;
etching the device layer to produce at least a first step the at least the first step forming a staircase structure;
trimming a sublayer of the photoresist layer stack, the sublayer being an optical planarizing layer (OPL) horizontally;
repeating etching the device layer and trimming the OPL horizontally to produce a second step of the staircase structure;
repeating etching the device layer and trimming the OPL horizontally to produce a third step of the staircase structure; and
removing the OPL and the plurality of hardmask segments.

15. The method of claim 14, wherein the plurality of photoresist sublayers of the hardmask layer stack comprise a first hardmask layer and second hardmask layer.

16. The method of claim 15, further comprising:
removing the second hardmask layer;
depositing a block photoresist over at least the staircase structure;
etching the device layer to produce binary structures; and
removing the first hardmask layer.

17. The method of claim 14, wherein the second plurality of photoresist segments are offset from the plurality of hardmask segments of the hardmask layer stack such that a portion of each of the plurality of second photoresist segments are disposed over a portion of the device layer or the substrate.

18. The method of claim 14, further comprising:
depositing a metal material over the substrate;
depositing a photoresist over the metal material deposited over the staircase structure; and
etching the metal material.

19. The method of claim 18, wherein the metal material is aluminum.

20. The method of claim 14, wherein the first step includes a first depth into the device layer, the second step includes a second depth into the device layer, and the third step includes a third depth into the device layer, the first depth being greater than the second depth and the second depth greater than the third depth.
